(19) United States
(12) Patent Application Publication
(10) Pub. No.: US 2016/0034542 A1
(43) Pub. Date: Feb. 4, 2016

(54) INTEGRATING VARIOUS SEARCH AND RELEVANCE PROVIDERS IN TRANSACTIONAL SEARCH

(71) Applicant: Microsoft Corporation, Redmond, WA (US)

(72) Inventors: Andre' Lamego, Copenhagen (DK); Maciej Plaza, Copenhagen (DK); Marcin Zieminski, Copenhagen (DK); Olga Turovceva Mulvad, Copenhagen (DK)

(21) Appl. No.: 14/446,850

(22) Filed: Jul. 30, 2014

(51) Int. Cl. G06F 17/30; G06F 7/24

(52) U.S. Cl. CPC G06F 17/30554; G06F 17/30528; G06F 7/24

(57) ABSTRACT

Search parameters are generated from search tokens that are entered within a transactional search context. A data provider is selected from a plurality of different data providers for executing a search, using the search tokens. Relevance calculators that calculate the relevance of matching search results, and sorting systems, that sort the search results, can also be selected from a plurality of different relevance calculators and sorting systems. The sorted search results are then displayed.

### BACKGROUND

Computer systems are currently in wide use. Some computer systems provide functionality for searching for data within a transactional context.

One example of such computer systems include business systems. Business systems can include, for instance, enterprise resource planning (ERP) systems, customer relations management (CRM) systems, line-of-business (LOB) systems, among others. These types of systems often provide applications that operate on business data. For instance, customer relations applications can operate on a wide variety of different types of customer records within the business system. Similarly, general ledger or other accounting types of applications can operate on customer, vendor, employee, or other data stored within the business system.

In using such systems, a user may manipulate data on a wide variety of different types of forms, that are used to present data to the user. Some such systems may have thousands of different forms, each of which may have hundreds of different controls for entering or manipulating data.

In performing the activities associated with their jobs, users often use forms to enter or manipulate data. While performing these types of operations, users may wish to search the system for other related information. By way of example, a user may open a sales order form to create or modify a sales order entity within the business system. In doing so, the user may open a sales order application that displays forms and that has functionality that allow the user to perform actions on transactional data, master data, etc., regarding sales orders. In the present description, a transaction is distinguished from a database transaction. A transaction in a database system may be, for instance:

begin;
update tableA set value+1;
update tableB set value=B. Value−1;
commit;
Instead, in the present discussion, a transaction can mean a business flow, a sequence of operations, a command sequence or a task. One example of a transaction may be, for instance, where a mechanic in an auto shop accesses the CRM system to see when a customer is coming to pick up her car. Each transaction can be unique within the business system (e.g., each transaction generating and sending a given sales order, making a given payment, shipping goods, moving inventory, etc, is unique). When the user pulls up a given form, and begins filling it out to perform a transaction, the system is in a certain transactional context. The context is that the user is performing some type of transaction (or operating on some transactional data) within a given business record. Within this transactional context, the user may wish to find additional information.

Some systems provide lookup functionality in such a context. For instance, on the sales order form, there may be a text box that allows the user to type in one or more words that may include wildcards and actuate lookup functionality. However, this type of functionality can revert to a table scan within the business system, which can severely degrade the performance of the system.

The discussion above is merely provided for general background information and is not intended to be used as an aid in determining the scope of the claimed subject matter.

### SUMMARY

Search parameters are generated from search tokens that are entered within a transactional search context. A data provider is selected from a plurality of different data providers for executing a search, using the search tokens. Relevance calculators that calculate the relevance of matching search results, and sorting systems, that sort the search results, can also be selected from a plurality of different relevance calculators and sorting systems. The sorted search results are then displayed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIGS. 1 and 1A (collectively FIG. 1) show a block diagram of one example of a business system, that includes a transactional search system.

FIG. 2A is a block diagram of one example of a set of sorting systems.

FIG. 2B is a block diagram of one example of a set of data providers.

FIG. 3 is a flow diagram illustrating one example of the operation of a transactional search configuration system in generating user input mechanisms that allow a user to configure a transactional search system.

FIGS. 3A-3O show examples of user interface displays.

FIGS. 4A and 4B (collectively FIG. 4) show one example of a flow diagram illustrating the operation of a transactional search system.

FIG. 4C-4E show examples of user interface displays.

FIG. 5 shows one example of a cloud computing architecture in which the system of FIG. 1 can be implemented.

FIGS. 6-8 show various embodiments of mobile devices.

FIG. 9 is a block diagram of one example of a computing environment.

### DETAILED DESCRIPTION

As mentioned above in the Background section, some computer systems (such as business systems) provide lookup functionality within a transaction scope. For instance, a user of a business system may wish to lookup an entity when in a sales order line of a sales order form. Some systems provide a lookup text box in which the user can type one or more keywords. This has a number of different drawbacks, however. For instance, the option to filter on such a lookup is limited. Similarly, while the user can apply certain types of grid filtering for item numbers within a business system, this can provide generally unacceptable performance. The lookup system may, for example, translate certain search terms in such a way that the resultant search technique is a table scan. However, this can mean that the system is attempting to scan millions of different records, and this can degrade the performance of the entire system. Similarly, different parts of the computer system (such as different parts of a business system) can have different lookup functionality. The lack of consistency can make it difficult for users to employ even the limited lookup functionality that is provided in some systems.

It will be noted that the concepts and features described herein can be applied to a wide variety of different types of computer systems where transactional searches are employed. The present description will proceed with respect to the computer system being a business system. However, it will be appreciated that a business system is only one example of a computer system to which the description applies, and it can apply to a wide variety of other computer systems as well.

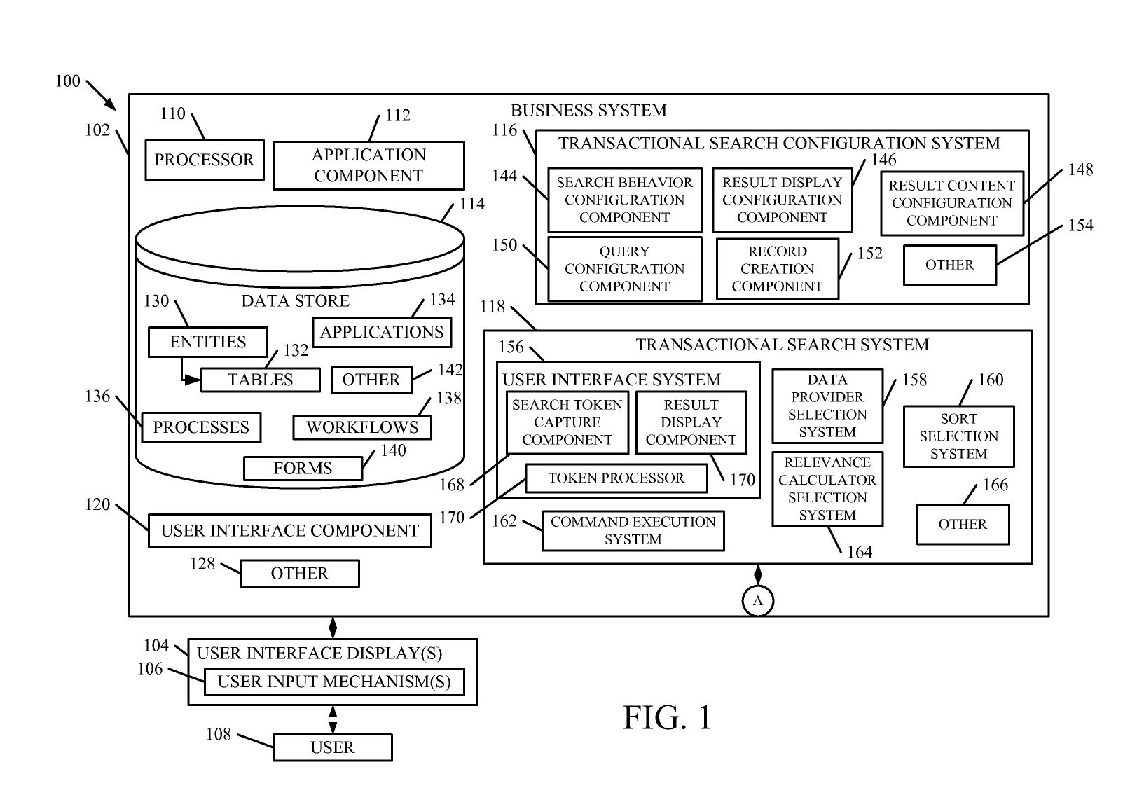

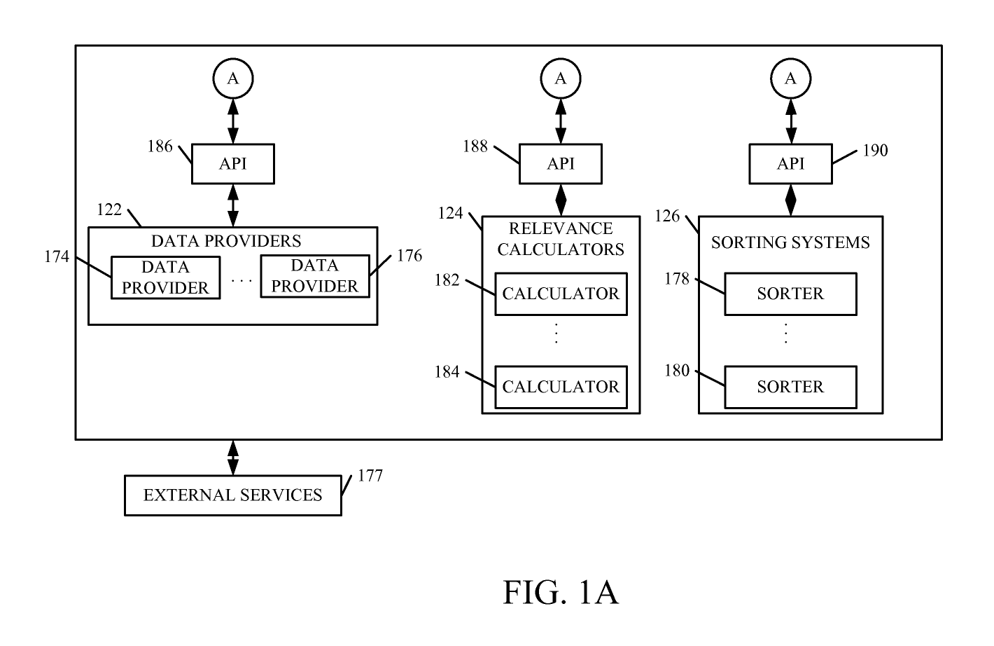

FIG. 1 is a block diagram of one example of a business system architecture 100. Architecture 100 illustratively includes business system 102 that generates user interface displays 104 with user input mechanisms 106 for interaction by user 108. User 108 can be a user of business system 102, an administrator of business system 102, or another type of user that interacts with business system 102. In any case, user 108 illustratively interacts with user input mechanisms 106 in order to control and manipulate business system 102.

Business system 102, itself, includes processor 110, application component 112, data store 114, transactional search configuration system 116, transactional search system 118, user interface component 120, and it can also include a set of data providers 122, relevance calculators 124, sorting systems 126, and other items 128.

Data store 114 illustratively includes entities 130 which can be stored (where data store 114 is a relational database, for instance) in tables 132. Data store 114 can also include applications 134, processes 136, workflows 138, forms 140 and it can include other data records 142 as well. Entities 130 illustratively define and represent entities within business system 102. For instance, a sales order entity defines and represents a sales order within business system 102. A customer entity defines and represents a customer. A vendor entity defines and represents a vendor. A quote entity defines and represents a quote. A business opportunity entity defines and represents a business opportunity, etc. This is only a small set of examples of the different type of entities that can be stored in data store 114.

Applications 134 can be a wide variety of different types of systems or applications that can be run. For instance, applications 134 can be general ledger or other accounting applications. They can include inventory tracking applications, sales tracking applications, business opportunity tracking applications, among a wide variety of other applications. Application component 112 illustratively runs applications 134 which, themselves, operate on entities 130 and perform processes 136 and workflows 138 and generate forms 140 for interaction by users 108.

Transactional search configuration system 116 illustratively includes search behavior configuration component 144, result display configuration component 146, result content configuration component 148, query configuration component 150, record creation component 152, and it can include other items 154 as well. Search behavior configuration component 144 illustratively generates user interface displays, with user input mechanisms, that allow an administrator to configure the search behavior of transactional search system 118. Result display configuration component 146 illustratively generates user input mechanisms that allow an administrator to configure the particular type of display used to display the search results when a user performs a transactional search using transactional search system 118. Result content configuration component 148 illustratively generates user input mechanisms that allow an administrator to configure the different types of content that are to be displayed for search results, when a user performs a transactional search using system 118. Query configuration component 150 illustratively generates user input mechanisms that allow an administrator to configure the types of queries that can be used, and how they are processed, within transactional search system 118. Record creation component 152 illustratively generates user input mechanisms that allow a user to create a new record based on the search results.

Transactional search system 118 illustratively includes user interface system 156, data provider selection system 158, sort selection system 160, command execution system 162, relevance calculator selection system 164 and it can include other items 166 as well. User interface system 156 illustratively includes search token capture component 168 that captures search tokens from a user who is performing a transactional search. System 156 also illustratively includes token processor 170 that processes the captured tokens into search parameters that are used in executing a search. Result display component 172 illustratively displays the search results to the user.

Data provider selection system 158 illustratively selects one of the data providers 122 (which can include a plurality of different individual data providers 174-176) for execution of the search using the search parameters. For instance, it may be that different types of search providers can provide better search performance in searching different types of data. By way of example, a full text search provider may provide good performance when searching product descriptions. However, it may provide inadequate performance when searching part numbers. This may be because the part numbers may be differentiated by only a single digit, while part descriptions may be significantly different from one another, based upon the part. Similarly, a data mining search provider may be good at performing certain types of data mining searches, while a simple query search component may be good at searching other data sources. Also, some specialized providers may provide more relevant data. This may be, for instance, where a dedicated provider used for searching products would include translations of product names, while the translation functionality is not used to look for other entities. Data provider selection system 158 thus selects a data provider 122 to execute the search based upon configuration inputs (discussed below) and based on the search parameters received from token processor 170. In one example, this can be done without requiring user input.

In the example shown in FIG. 1, data provider selection system 158 can also select from a wide variety of different external data provider services 177. This is also described in greater detail below.

Sort selection system 160 illustratively selects one of a plurality of different sorting system 126 (which can include a plurality of different individual sorters 178-180). For instance, some sort systems may sort search results based upon whether they are sponsored by other companies or unsponsored. Some sort providers may include search results from related searches. They may also sort data based on different analytics. System 160 can select an external sorting system as well. Sort selection system 160 selects one of the sort systems 126 for sorting the matched results obtained from the selected data provider.

Relevance calculator selection system 164 illustratively selects one of the relevance calculators 124 (which can include a plurality of different individual relevance calculators 182-184). The selected relevance calculator assigns a relevance to each of the matching search results received from the selected data provider that executed the search. The relevance can be calculated differently, by different relevance calculators 182-184.

Command execution system 162 illustratively executes any commands that are received along with the query.

Data providers 122 illustratively expose an application programming interface (API) 186. Relevance calculators 124 illustratively expose an API 188, and sort systems 126 illustratively expose an API 190. The various components of transactional search system 118 invoke APIs 186-190 in order to select, and communicate with, the various data providers 122, relevance calculators 124 and sorting systems 126 for a given transactional search.

Before describing the operation of transactional search configuration system 116 in allowing an administrator to configure transactional search system 118, a number of examples of sorting systems and data providers will be discussed. Of course, the following discussion is only by way of example, and other sorting systems and data providers could be used as well. In addition, a wide variety of different types of relevance calculators 124 can be used. Also, some of the sorting systems and relevance calculators can be implemented within the data providers. Likewise, the data providers, sorting systems and relevance calculators can be combined in various other ways.

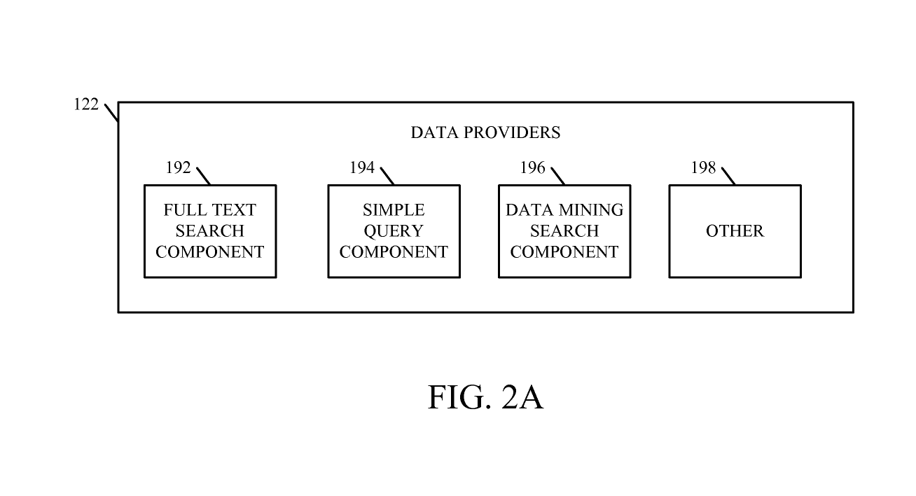

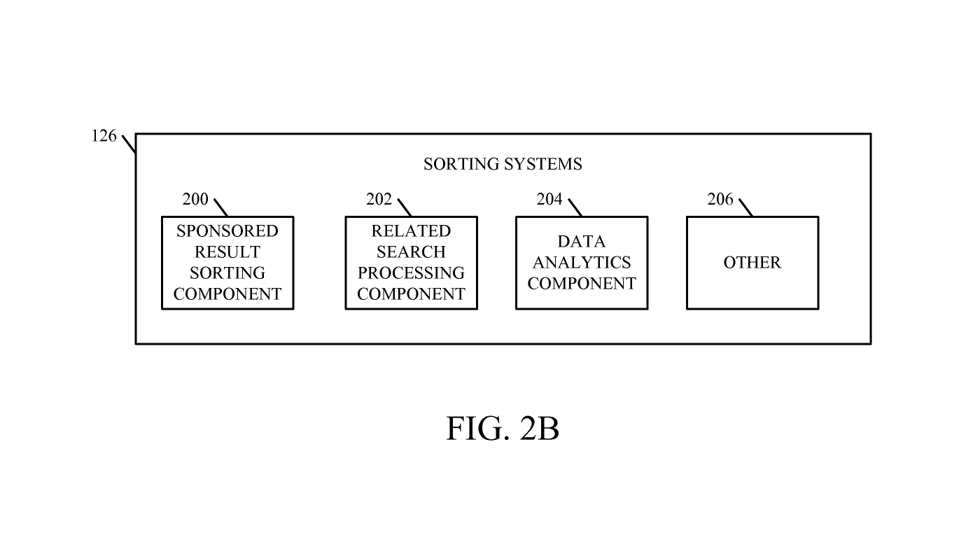

FIG. 2A is a block diagram of one example of a set of data providers 122. Data providers 122 illustratively include full text search component 192, simple query component 194, data mining search component 196, and it can include other types of data providers 198 as well. Full text search component 192 illustratively performs a full text search using the search parameters that are generated based on the search tokens input by the user. Simple query component 196 performs a simple query based on those search parameters, and data mining search component 196 can perform a variety of different data mining operations based on those search parameters. A number of examples of these data providers are described below.

FIG. 2B shows one example of a set of sorting systems 126. The sorting systems 126 shown in FIG. 2B include a sponsored result sorting system 200, a related search processing component 202, a data analytics component 204, and it can include other sorting systems 206 as well. Sponsored result sorting component 200 can illustratively sort sponsored search results to the top of the result set. Related search processing component augments the search results with search results that were generated using related searches, and that were interacted with by the user that generated those related searches. Data analytics component 204 can perform a wide variety of different types of data analytics to sort various search results to the top of the result set. For instance, data analytics component 204 can identify which search results are most popular within business system 102, or which are currently trending in various other environments, and sort those results to the top of the result set. Of course, these are only examples.

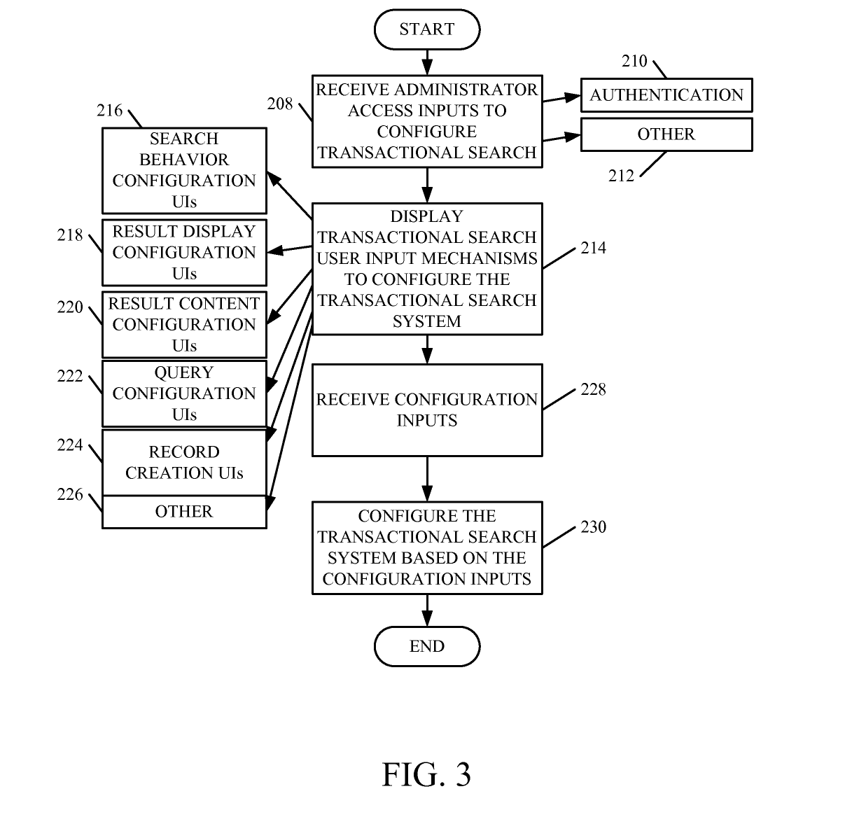

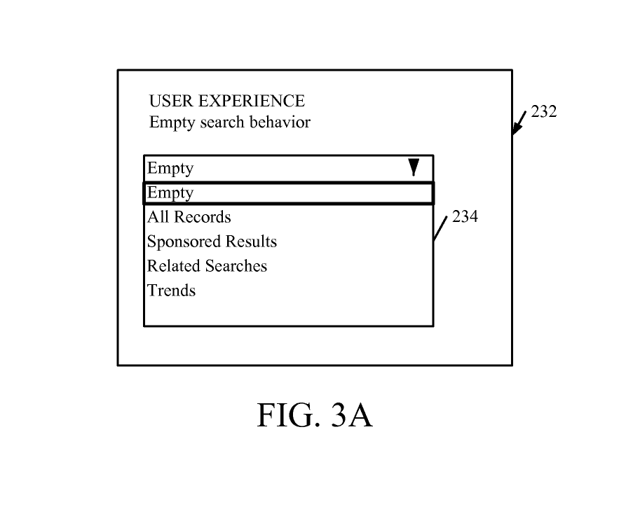

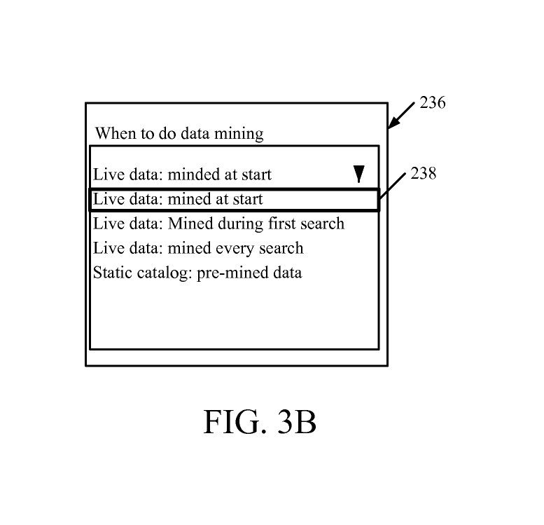

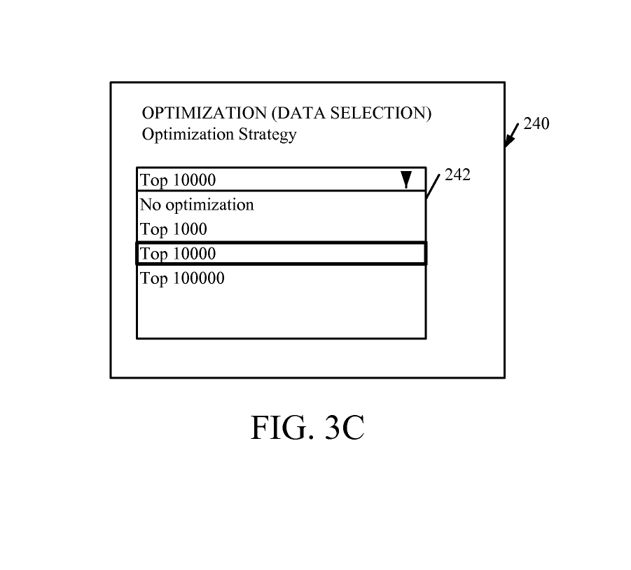

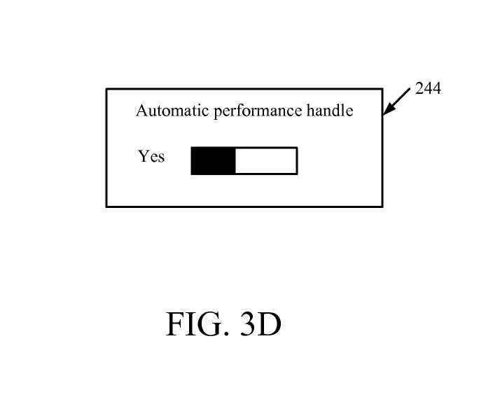

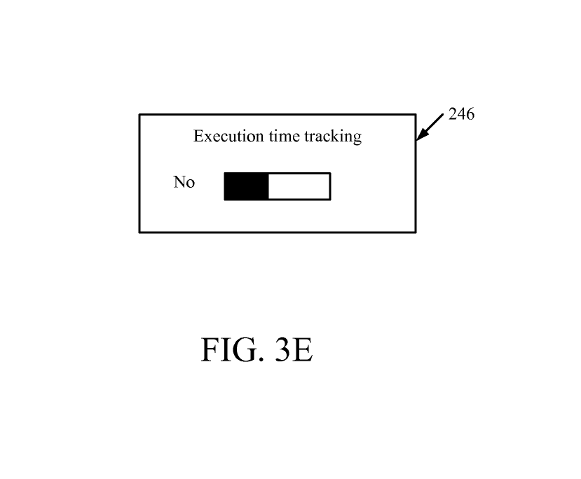

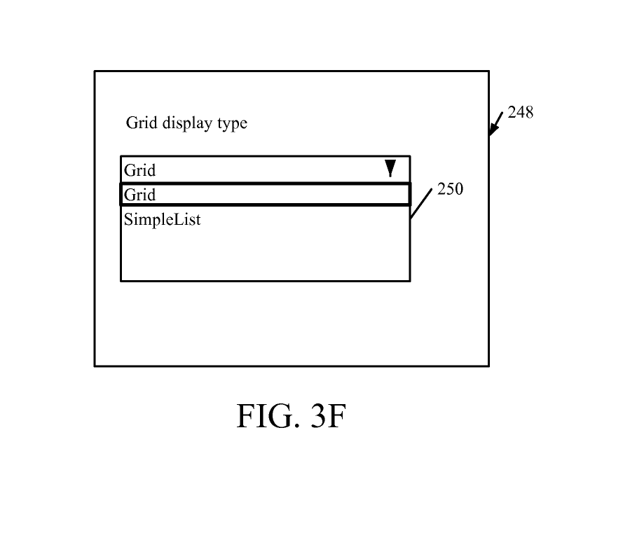

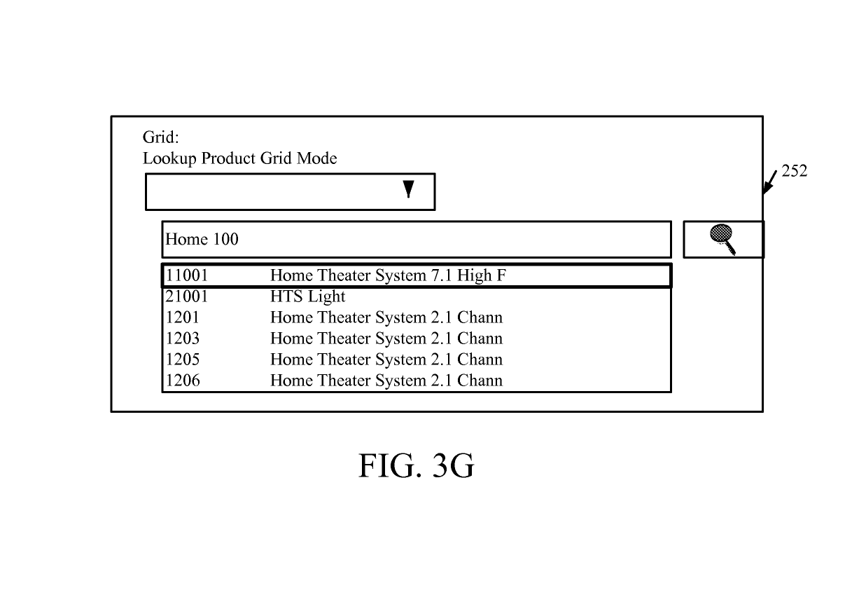

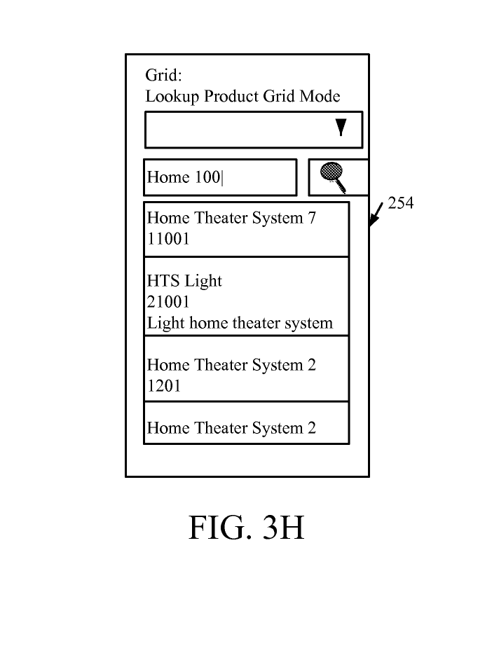

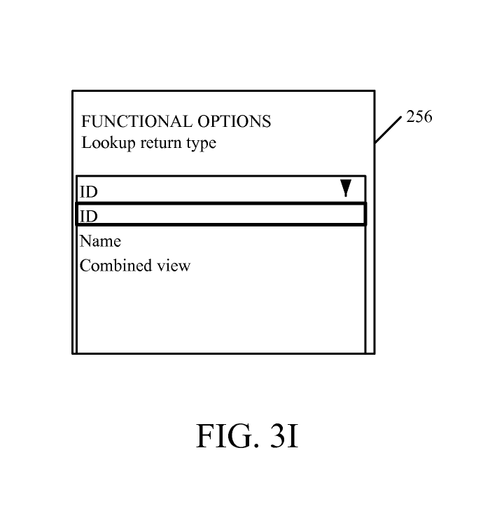

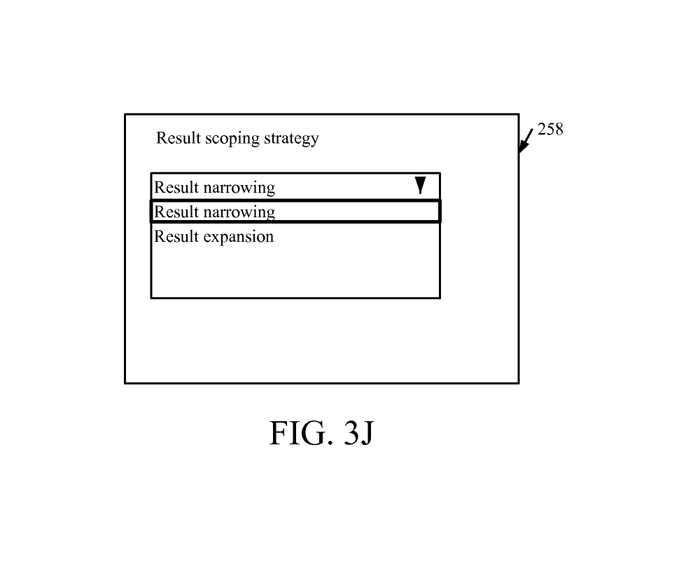

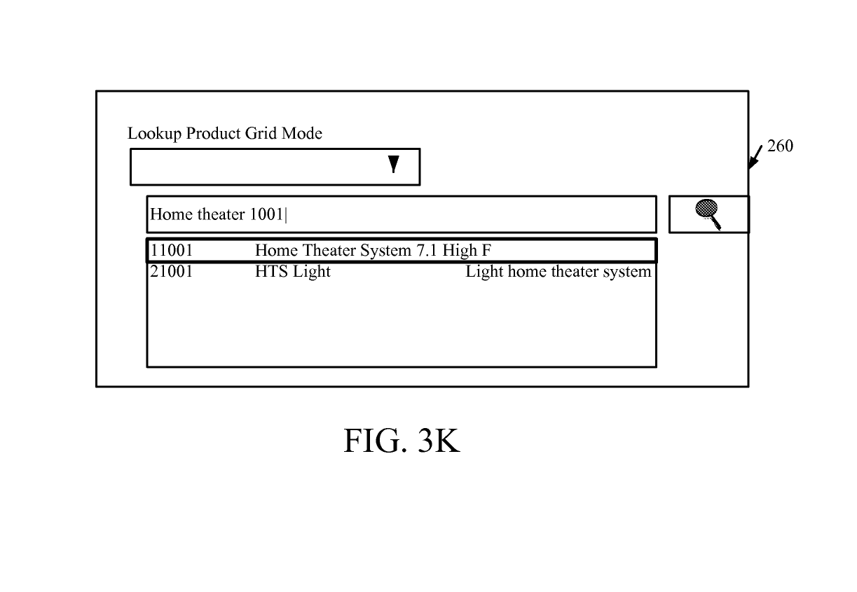

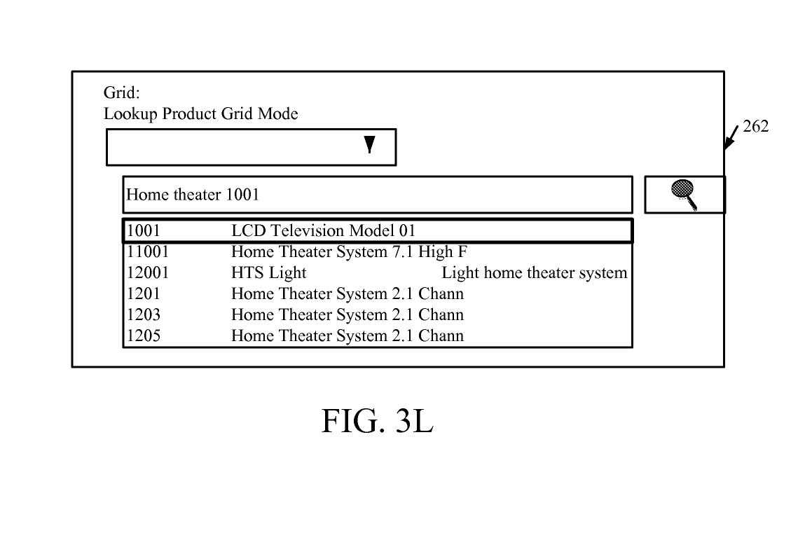

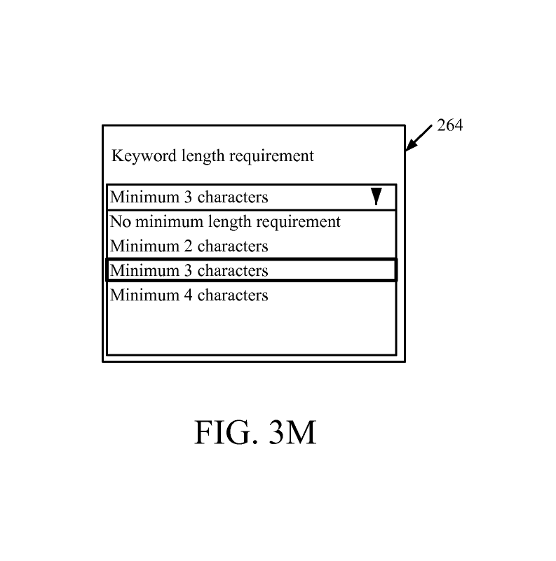

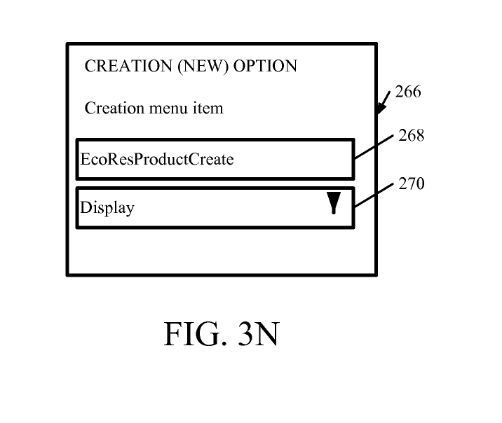

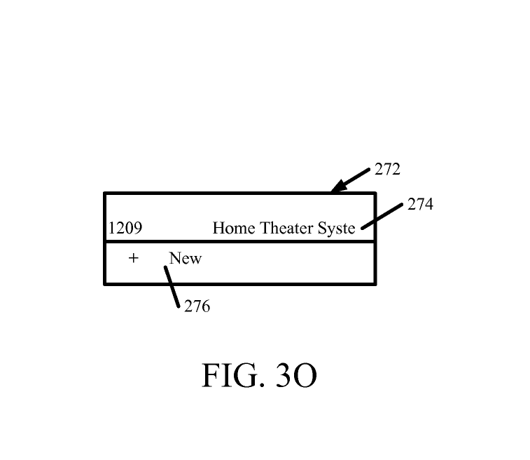

FIG. 3 is a flow diagram illustrating one example of the operation of transactional search configuration system 116 in generating user input mechanisms that allow an administrator to configure the operation of transaction search system 118. FIGS. 3A-3O show various user interface displays, with various user input mechanisms, that illustrate one example of this in more detail.

Transactional search configuration system 116 first receives access inputs from an administrator that indicate that the administrator wishes to configure the transactional search system 118. This is indicated by block 208 in FIG. 3. This can include, by way of example, authentication information (such as a username and password, etc.) 210 or other information 212.

Transactional search configuration system 116 then displays transactional search user input mechanisms that allow the administrator to configure the transactional search system 118. This is indicated by block 214. By way of example, search behavior configuration component 144 generates search behavior configuration user input mechanisms 216. Result display configuration component 146 generates result display configuration user input mechanisms 218. Results content configuration component 148 generates result content configuration user input mechanisms 220. Query configuration component 150 generates query configuration user input mechanisms 222. Record creation component 152 generates record creation user input mechanisms 224, and other items can generate other user input mechanisms 226 as well.

The various components in transactional search configuration system 116 then receive configuration inputs from the administrator. This is indicated by block 228. Those components then configure the transactional search system 118, based upon the configuration inputs received. This is indicated by block 230 in FIG. 3.

FIGS. 3A-3O show a variety of different examples of user interface displays, with user input mechanisms, that can be generated to allow an administrator to configure a transaction search system. These figures will be described as but one example of how such user input mechanisms can be generated and used to configure the transactional search system. Also, while different display elements and user input mechanisms are shown separately, they can be grouped onto one or more user interface displays.

FIG. 3A shows one example of a user interface display element 232. Display element 232 provides user input mechanism 234 that allows the administrator to configure the search behavior of transactional search system 118. In the example shown in FIG. 3A, mechanism 234 is a dropdown menu that allows the administrator to select a variety of different types of search behavior. When the administrator selects the “Empty” behavior, transactional search system 118 does not consume resources and execute database calls until the user has completed entering the search. Instead, it simply prompts the user to begin typing in search terms. When the administrator selects the “All Records” behavior, database calls are executed as the user is typing the search terms, and the top n (where n is an integer selected by the administrator) records that match the search are displayed.

In one example, the system can be extended to include other options as well, by invoking systems or components that implement the corresponding API. For example, where the administrator selects the “Sponsored Results” behavior, this configures sort selection system 160 to preferentially select the sponsored result sorting component 200, so that sponsored results are preferentially placed near the top of the result set. For example, if a company has a relatively high inventory of red shirts, it can encourage the user performing the search to attempt to sell them first.

If the administrator selects the “Related Searches” behavior, this configures sort selection system 160 to preferentially invoke the related search processing component 202. Where the computer system is a business system, related search processing component 202 will include search results that are associated with entities that are found in the same context as the entity from which the user is executing the search. For example, if the user is in a purchasing form entity so that the user is attempting to purchase an item (such as a home theater system) the system may identify an entity corresponding to an LCD television as being related to the home theater system entity. Therefore, it may preferentially surface search results related to LCD televisions, along with the search results related to the home theater system.

If the administrator selects the “Trends” behavior, this causes sort selection component 160 to preferentially invoke the data analytics component 204. This allows the sorting system to use data analytics to infer various results for the present context. Component 204 may, for example, consider other searches that were performed by other users, after they performed the search currently entered by the present user, and surface the results of those searches as well.

FIG. 3B shows one example of a user interface display element 236 that displays a user input mechanism 238 that allows the administrator to further define the search behavior of transactional search system 118. In the example shown in FIG. 3B, mechanism 238 allows the administrator to select when data mining operations are performed for a given transactional search. For instance, some data mining operations can include preparing a database state for being searched, and preparing a searchable data view. By way of example, when the administrator selects the “Live data mined at start” option, this causes data provider selection system 158 to invoke data mining search component 196 so that the search is executed against live data in the database. When the administrator selects the “Live data mined during first search” option, the data that is searched is live within the database, but the searchable data view is prepared for search when the user types search criteria for the first time during the present context. When the administrator selects the “Live data mined every search” option, the data is live and the searchable data view is prepared for search every time a search is entered, regardless of whether it is the first time. When the administrator selects the “Static catalog: pre-mined data” option, the search query is executed against pre-processed, pre-mined data which may be optimized for full text searching using full text search component 192. Again, these are simply examples.

FIG. 3C shows another example of a user interface display element 240 that can be generated to allow the user to configure the search behavior of transactional search system 118. Display element 240 illustratively includes user input mechanism 242 that allows the administrator to set an optimization strategy for the search. The optimization strategy illustratively controls the limiting record count that is passed to the selected data provider 122. It can be useful to optimize or increase the efficiency of various database server instances when the search tokens may generate a very long search operation using full text searching.

FIG. 3D shows one example of a user interface display element 244 that allows the administrator to set an automatic performance handling mechanism. When this is invoked, transactional search system 118 can invoke a variety of different heuristics to achieve improved search performance. While the heuristics may be simple or complicated, they can be employed by the various components of transactional search system 118 in order to improve search performance. For instance, a first heuristic may indicate that when the user has set the data mining criteria to “Live data”, there may be the potential that the data composition on the live tables has grown to a size that makes the search relatively slow. In this case, data provider selection system 158 first obtains a rough count of the number of records from the primary table of the entity being searched (the entity that relates to the context within which the user has launched the search). The rough count is compared to a threshold value and the particular data mining operations that are performed can be directed by data provider selection system 158 to improve the search performance. For instance, if the rough count indicates that the size of the table representing the entity being searched is in excess of 10,000 records (by way of example only), then the data provider selection system 158 selects a data mining search component 196, but selects the data mining operations to the “Static catalog” option so that the search is only performed against pre-processed, pre-mined data. Thus, a full text search algorithm can be employed.

A second heuristic may determine that the data mining settings are set to “Static catalog”. It may indicate a minimum character count for keywords that are passed into the full text search mechanism.

A third heuristic may determine that the data mining settings are set to the “Static catalog” option and, after the second heuristic discussed above is applied, the number of search keywords is counted. If there is more than one search keyword, then the limiting record count retrieved from the full text search can be set to a predetermined value (such as a 10,000 records). If there is only one search keyword or no search keywords after the second heuristic is applied, then the limiting record count retrieved from the full text search may be set to a lower number, such as 1,000. This will ensure that the selected data provider is not attempting to retrieve records that match a very low number of keywords, with only few letters.

A fourth heuristic may turn off the first three heuristics before the search results are passed to the selected relevance calculator. Thus, the relevance calculator will calculate relevance without the restrictions imposed by the first three heuristics. It can thus be seen that, using this approach, the first three heuristics control how the data is mined and retrieved during the search conducted by the data provider. They do not affect how the relevance calculator works. Instead, the first three heuristics can be used to increase the performance of the search in terms of speed and volume of data so that the volume of data is manageable by the relevance calculator. Therefore, the last heuristic can remove the limitations of the first three heuristics once the relevance calculator has received the search results.

FIG. 3E shows an example of another user interface display element 246. Display element 246 illustratively allows the administrator to further define the search behavior of transactional search system 118. Display element 246 allows the administrator to turn on an execution time tracking mechanism that records the time that the search process takes within transactional search system 118. For example, each portion of the search can include a separate time tracking component that is enabled so that it tracks the time taken by each of the components (the data provider in executing the search, the relevance calculator in calculating relevance and the sorting system in sorting the search results) in performing their respective operations. This can enable efficient diagnostics of portions of the system that may be bottlenecks.

FIG. 3F shows an example of another user interface display element 248. Display element 248 can be used by an administrator to configure the type of display that is used to display the search results to the user. In one example, determining how to display the results can be done automatically based on a context the user is in, without depending on administrative input. For instance, the results can be automatically displayed differently based on a device the user is using. In the example shown in FIG. 3F, user input mechanism 250 allows the administrator to select a “grid” display type or a “simple list” display type. One example of a grid display is shown as display 252 in FIG. 3G. It can be seen that the user has entered the search term “home 100” and the search results are displayed in a “grid”. FIG. 3H shows an example of a “simple list” display 254. Again, the user has entered the search terms “home 100”. The “simple list” display displays each entry's field stacked vertically. This increases the vertical display real estate corresponding to each item in the list, and thus can enable easier touch gestures on a touch sensitive display, especially on a smaller screen device, such as a mobile device.

FIG. 3I shows an example of a user interface display element 256. Display element 256 allows the administrator to configure the particular content that is to be displayed along with each search result. In the example shown in FIG. 3I, the administrator can include the identifier (or “ID”) of a business record, the “name” of the business record, or both. In another example, the content that is to be included in the result set can be determined automatically based on user context, without depending on administrative input. For instance, depending on where (in terms of context) the user is in the system, the user may need different content in the search results. This can be determined heuristically, using mapping or machine learning, etc.

FIG. 3J shows an example of a user interface display element 258 that allows an administrator to configure various characteristics of the query that is to be executed. User interface display element 258 allows the administrator to select a scoping strategy to be used during search execution of a query. In the example shown in FIG. 3J, the administrator can select a “result narrowing” strategy or a “result expansion” strategy. In one example, when the user selects the “result narrowing” strategy, the token processor 170 in user interface system 156 adds (either explicitly or implicitly) an “and” between the search keywords. FIG. 3K shows one example of a user interface display 260 that shows results produced with a “result narrowing” strategy. It can be seen that the user has typed “home theater 1001”. The system adds an “and” between each of the search terms to narrow the scope of the search to identify fewer search results. In another example, the search strategy configuration option may not be exposed to an administrator. For instance, it may be determined that a certain search strategy is always desired in certain contexts or applications. In those cases, the search strategy may be set and not necessarily changeable by an administrator.

FIG. 3L shows an example of a user interface display 262 that is generated using a “result expansion” strategy. In one example of the “result expansion” strategy, the system places an “or” between the search keywords. This search strategy may be employed, for instance, when the system relies more heavily on the sort system to order the records or the relevance calculator to calculate how well the records match the search criteria. FIG. 3L shows, of course, that using the expansion strategy, more search results are returned.

FIG. 3M shows one example of a user interface display element 264 that can be used by an administrator to set any keyword length requirements for use in the searching process. It can be seen in FIG. 3M that the administrator can choose for there to be no minimum length requirement or the administrator can select a certain number of characters as the minimum character count for each keyword. This can be implemented by the token processor 170 so that keywords that are entered by the user in the search query, but that are not sufficient length, are removed prior to the search tokens being provided to the selected data provider. Again, the relevance calculator may be able to process the results without taking this into account. This may allow the relevance calculator and the sorting system to calculate a relevance and sort the search results more accurately.

FIG. 3N shows one example of a user interface display element 256 that can be used by an administrator to create a new record from the search results. For instance, display element 266 includes user input mechanisms 268 and 270. User input mechanism 268 allows the administrator to name a new record that is to be created from the search results. Mechanism 270 allows the administrator to select the type of display that will be used to display that record. When the administrator has provided a valid menu item name using mechanism 268, then the transactional search system 188 illustratively generates a user interface display that allows the user to create a new record directly from the lookup results. FIG. 3O shows one example of a user interface display 272 that does this. User interface display 272 shows a set of underlying search results 274 and a user input mechanism 276 that can be actuated by the user in order to create a new record within the computer system, for displaying those search results.

It will be noted, of course, that the examples described above with respect to FIGS. 3A-3O are only examples. A wide variety of other user interface displays, with user input mechanisms, can be displayed to allow an administrator to further configure the behavior or other characteristics of transactional searches conducted by transactional search system 118. Before proceeding with a more detailed description of the operation of transactional search system 188, however, a number of items are worth noting. It can be seen that system 118 is scalable to easily accommodate other data providers 122, relevance calculators 124, or sorting system 126. In order to add any of these components, they simply implement the corresponding API 186-190. When they do this, they can be selected by the corresponding selection system 158, 160 or 164, respectively. Thus, as new data providers are implemented for increasing the performance of various different types of searches, or where new relevance calculators are implemented that improve relevance calculation, or further where new sorting systems are implemented which use better sorting mechanisms, those items can be selected by transactional search system 118 under the appropriate circumstances, in order to increase search performance. The search system 118 can thus select a best data provider, relevance calculator and/or sorting system, based on the search itself, based on the configuration inputs, based on the estimated result set, etc.

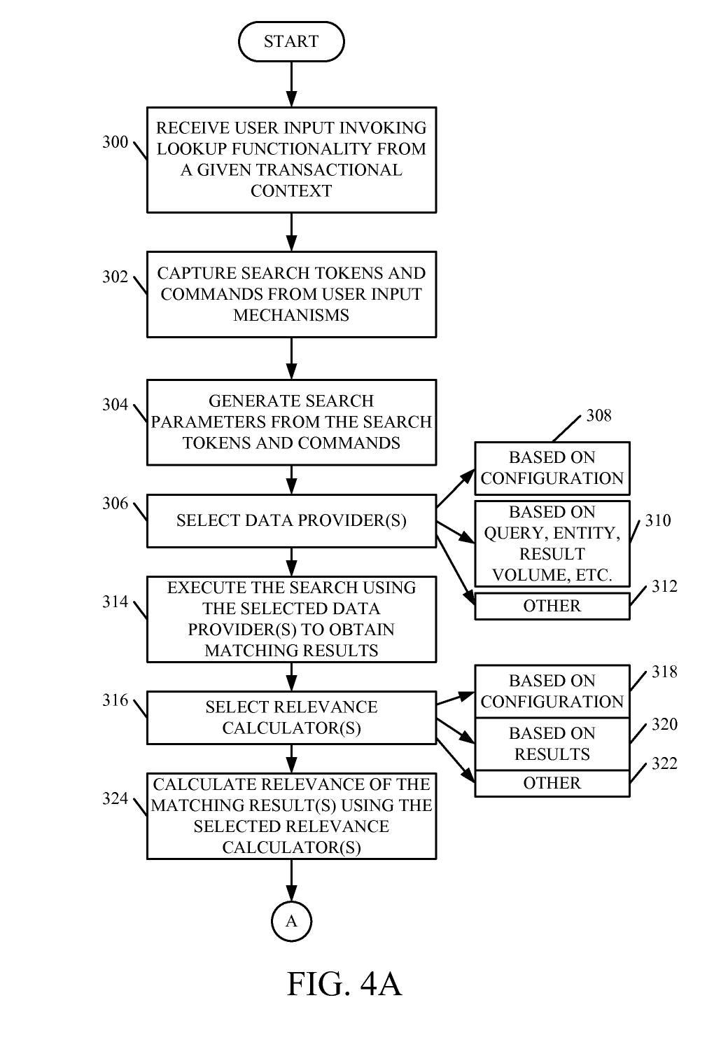

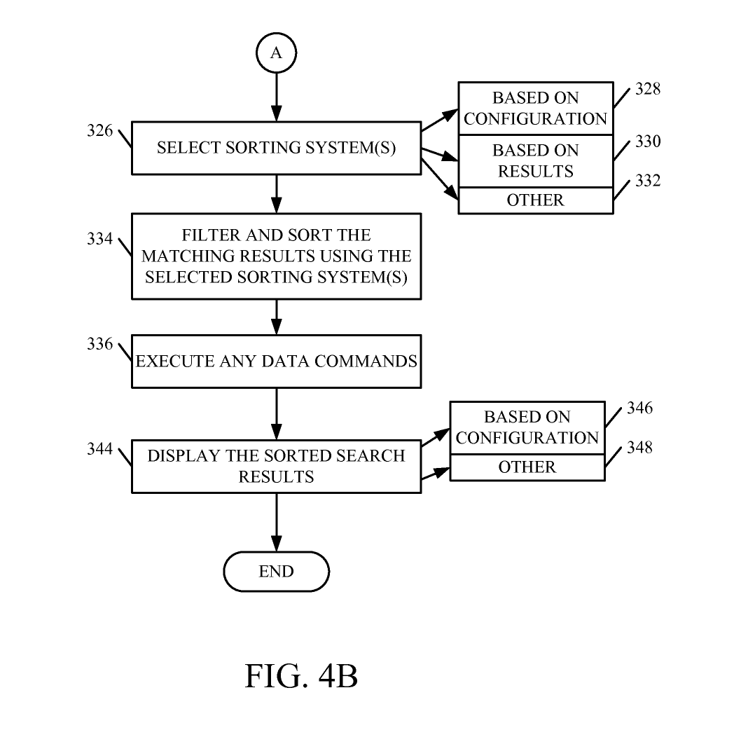

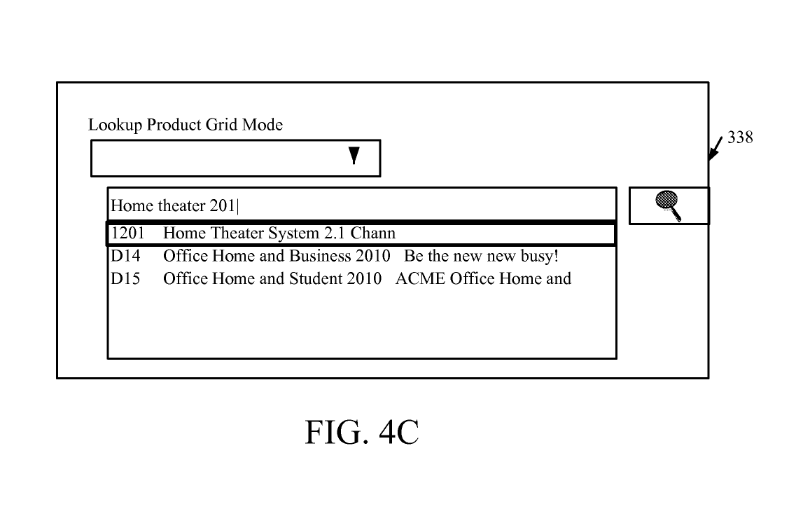

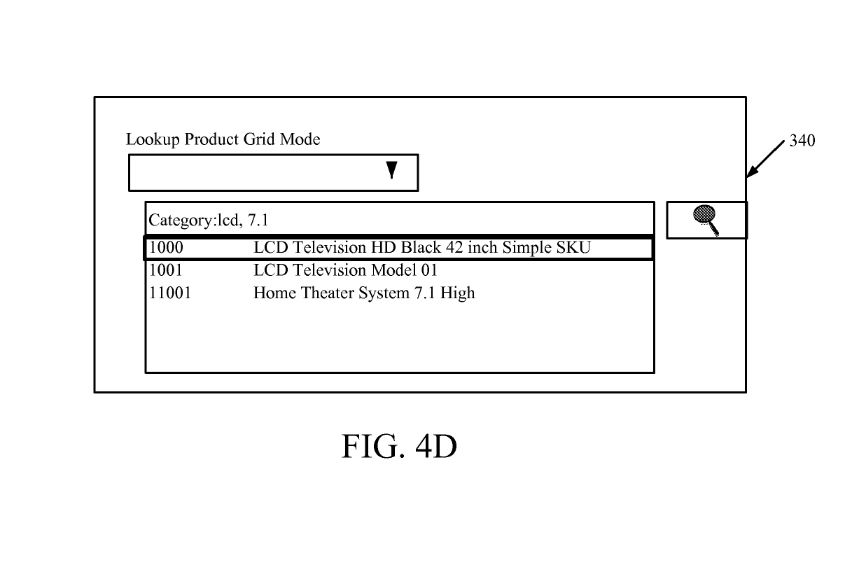

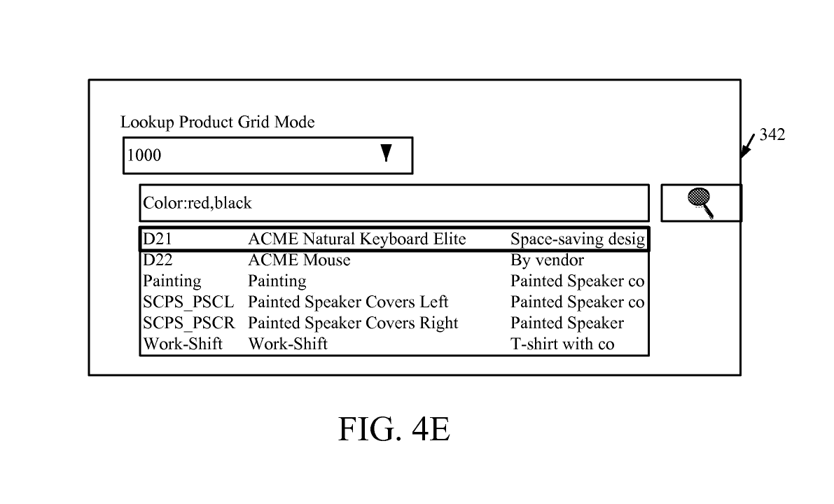

FIGS. 4A-4B (collectively FIG. 4) show a flow diagram illustrating one example of the operation of transactional search system 118. Transactional search system 118 first receives a user input invoking lookup functionality from a given transactional context. This is indicated by block 300 in FIG. 4. Search token capture component 168 then captures the search tokens input by the user and various commands that can also be input along with the search tokens. This is indicated by block 302. Token processor 170 generates search parameters from the search tokens and commands. This is indicated by block 304. In doing so, it implements the various configuration inputs that were received through the query configuration component 150 in the transactional search configuration system 116.

Once the search parameters are generated, they are provided to data provider selection system 158 which selects the appropriate data provider. This is indicated by block 306. As discussed above, system 158 can select the data provider based upon the configuration inputs, as indicated by block 308. It can also select the data provider based upon the query, the entity being search, the transactional context, the estimated volume of search results, among a wide variety of other things. This is indicated by block 310. The data provider can be selected in other ways as well, as indicated by block 312. The data provider selection system 158 then provides the search parameters to the selected data provider through API 186, for execution of the search. Executing the search using the selected data provider to obtain a set of matching results is indicated by block 314.

Relevance calculator selection system 164 selects a relevance calculator for calculating the relevance of the matched search results. This is indicated by block 316. Again, this can be based upon the various configuration inputs 318. It can be based upon the search results, themselves, as indicated by block 320, or it can be based on other criteria 322. The relevance calculator selection system 164 then passes the matching search results to the selected relevance calculator through API 188 and the selected relevance calculator calculates the relevance of the matching results. This is indicated by block 324. The particular relevance calculation can be done using a wide variety of different relevance calculation mechanisms.

Sort selection system 160 selects the sorting system that will be used to sort the search results. It then uses API 190 to pass the search results (and calculated relevance measures) to system 126 where they are sorted and passed back, in sorted form. The selection of the sorting system is indicated by block 326. It can be selected based upon the configuration inputs as indicated by block 328. It can be selected based upon the volume or other characteristics of the results as indicated by block 330, or it can be selected in other ways as well, as indicated by block 332. The search results are then filtered and sorted by the selected sorting mechanism. This is indicated by block 334.

Command execution component 162 then executes any data commands against the results. This is indicated by block 336. FIGS. 4C-4E show user interface displays which illustrate examples of this. FIG. 4C shows, for instance, a user interface display 338 that includes a set of preliminary results (which have not had commands executed against them yet). FIG. 4D shows a user interface display 340 that can be generated when the command execution system 162 executes a command that the category for the displayed results be LCD, 7.1. FIG. 4E shows a user interface display 342 that displays results where command execution system 162 executes a command that indicates that the color should be red or black. In each case, the displayed result set is modified based on execution of the command. Executing the data commands is indicated by block 336 in the flow diagram of FIG. 4.

The final search results are then displayed to the user. This is indicated by block 344. Again, the particular type of display used can be based upon the configuration information as indicated by block 346 or it can be determined in other ways as well, as indicated by block 348.

It can thus be seen that the transactional search system can be configured to select one of a plurality of different data providers. It can also be configured to select one of a plurality of different relevance calculators and sorting systems. All of the selection systems can be configured to perform the selections of data provider, relevance calculator and sorting system, in order to achieve best search performance. This significantly increases the performance of the computing system, itself. The system framework described herein is also highly scalable. Different data providers can be added, along with relevance calculators and sorting systems, as desired. They do this by implementing the appropriate API and they can be used in both configuration and runtime search processing.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

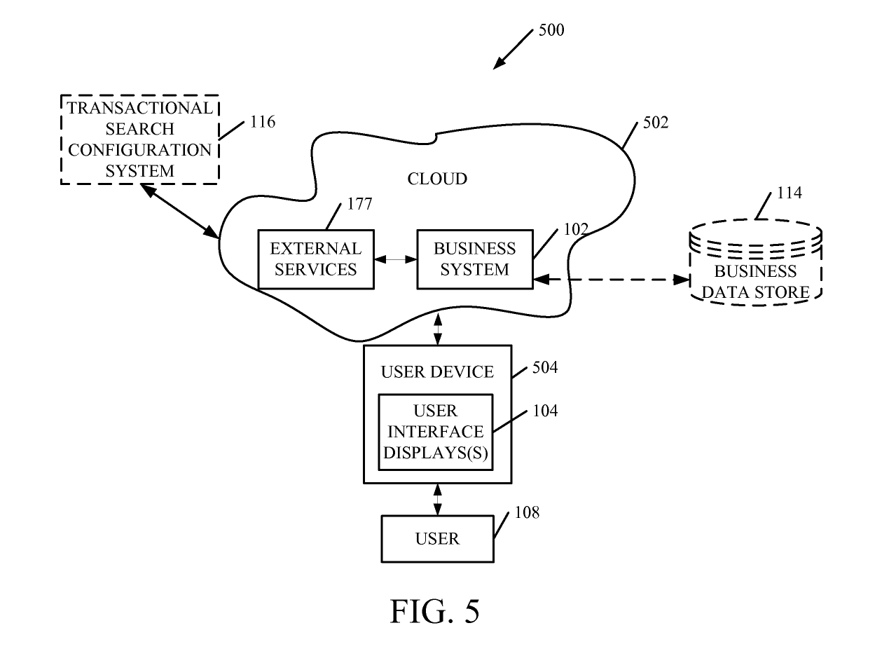

FIG. 5 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that business system 102 and external services 177 can be located in cloud 502 (which can be public, private, or a combination where portions are public while others are private). Therefore, user 108 uses a user device 504 to access those systems through cloud 502.

FIG. 5 also depicts another embodiment of a cloud architecture. FIG. 5 shows that it is also contemplated that some elements of business system 102 can be disposed in cloud 502 while others are not. By way of example, data store 114 can be disposed outside of cloud 502, and accessed through cloud 502. In another embodiment, transactional search configuration system 116 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

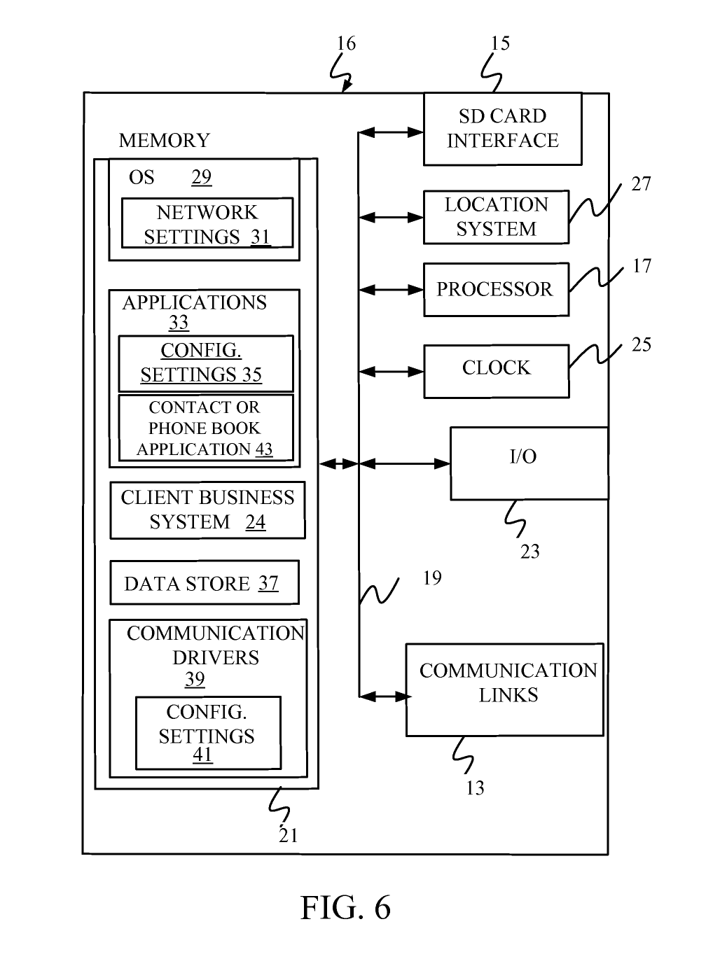

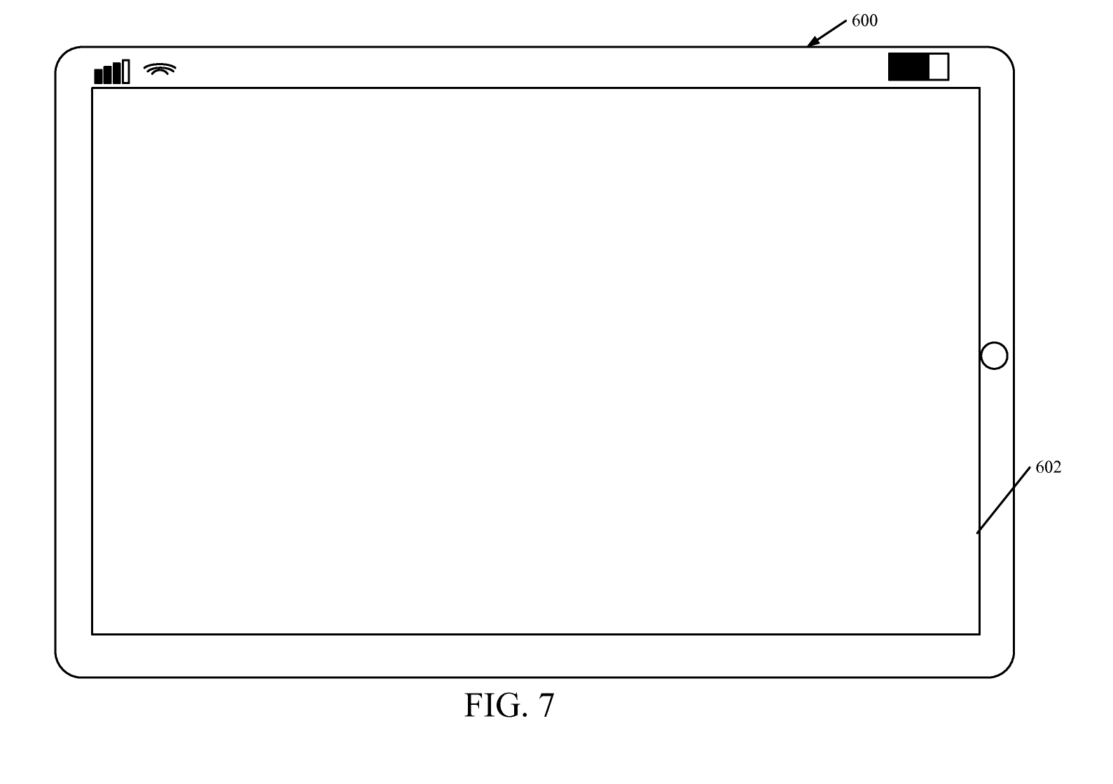

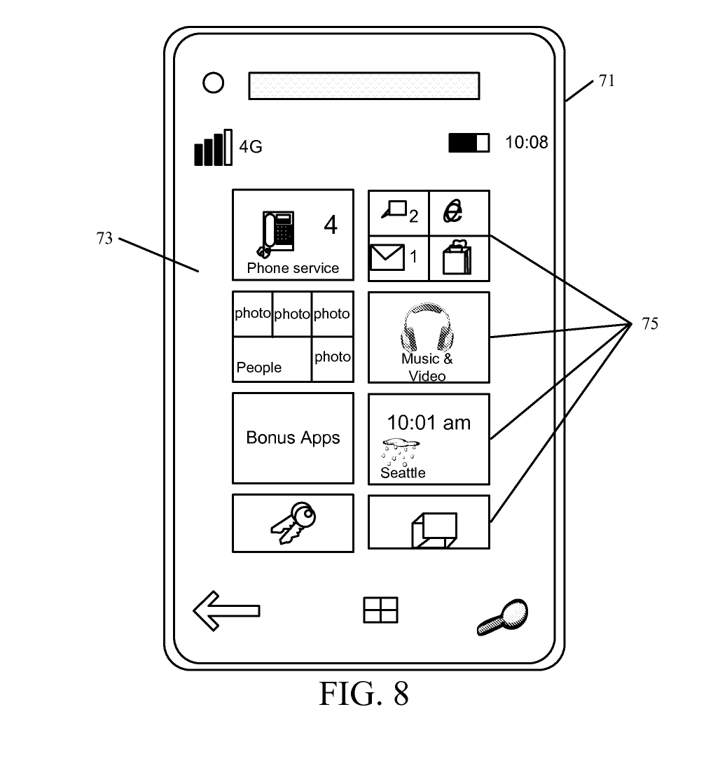

FIG. 6 is a simplified block diagram of one illustrative embodiment of a handheld or mobile computing device that can be used as a user's or client's hand held device 16, in which the present system (or parts of it) can be deployed. FIGS. 7-8 are examples of handheld or mobile devices.

FIG. 6 provides a general block diagram of the components of a client device 16 that can run components of business system 102 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 (which can also embody processor 110 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Application 154 or the items in data store 156, for example, can reside in memory 21. Similarly, device 16 can have a client business system 24 which can run various business applications or embody parts or all of tenant 104. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can also be used. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some embodiments, the phone also includes a Secure Digital (SD) card slot that accepts a SD card.

The mobile device can also be a personal digital assistant (PDA) or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 8 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

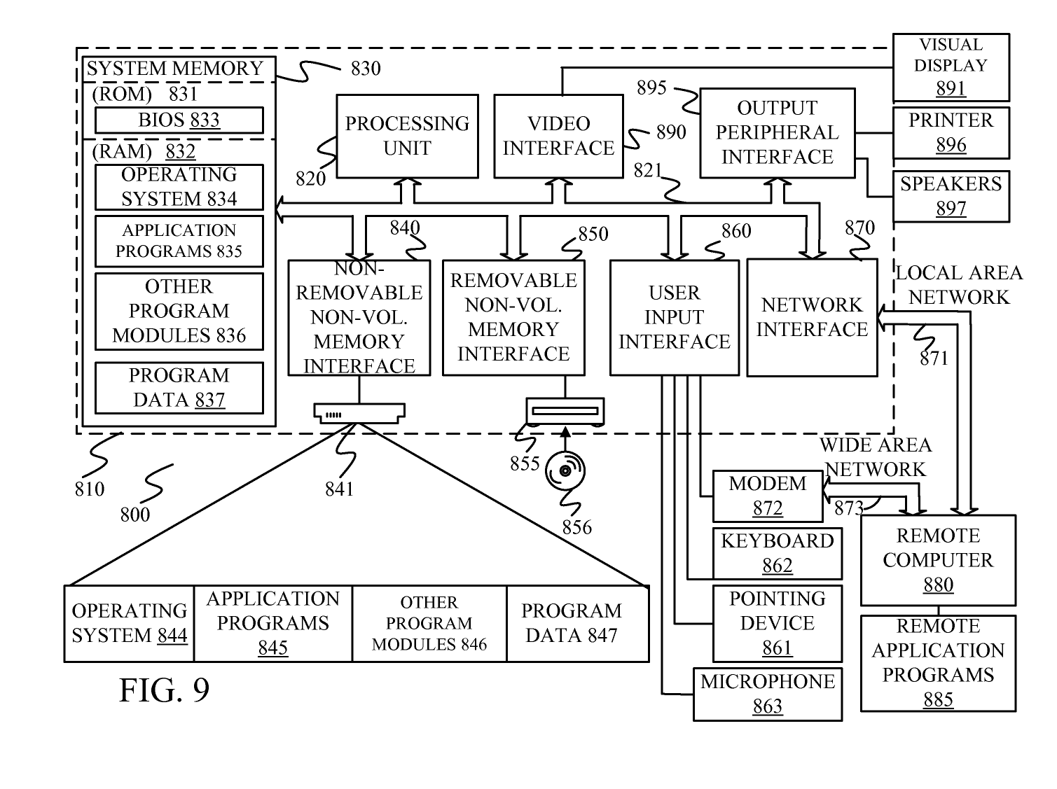

FIG. 9 is one embodiment of a computing environment in which architecture 100, or parts of it, (for example) can be deployed. With reference to FIG. 9, an exemplary system for implementing some embodiments includes a general-purpose computing device in the form of a computer 810. Components of computer 810 may include, but are not limited to, a processing unit 820 (which can comprise processor 110 or a processor in one of user devices 504), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 9.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 9 illustrates operating system 834, application programs 835, other program modules 836, and program data 837.

The computer 810 may also include other removable/non-removable volatile/nonvolatile computer storage media. By way of example only, FIG. 9 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 9, provide storage of computer readable instructions, data structures, program modules and other data for the computer 810. In FIG. 9, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computer system, comprising:

a search system, comprising:

a user interface system that generates a user interface display in a transactional context, with a search user input mechanism and generates search parameters based on search user inputs received through the search user input mechanism;

a search selection system that selects a given search component, from a plurality of different selectable search components, for performing a search using the search parameters to obtain search results, the search selection system selecting the given search based on search characteristics; and

a result display component that receives the search results and generates a search result display based on the search results; and

an application component that runs an application that defines at least a portion of the user interface displayed by the user interface system.

Example 2 is the computer system of any or all previous examples wherein the search selection system comprises:

a data provider selection system that selects a given data provider, from a plurality of different selectable data providers, for execution of the search using the search parameters to obtain search results, the data provider selection system selecting the given data provider based on the search characteristics.

Example 3 is the computer system of any or all previous examples wherein the computer system comprises a business system and wherein the given data provider searches a business data store for business records matching the search parameters.

Example 4 is the computer system of any or all previous examples and further comprising:

a sort selection system that selects a given sorting system, from a plurality of different selectable sorting systems, to sort matching results identified by the given data provider, the sort selection system selecting the given sorting system based on sort configuration inputs.

Example 5 is the computer system of any or all previous examples and further comprising:

a relevance calculator selection system that selects a given relevance calculator, from a plurality of different selectable relevance calculators, to calculate a relevance value for each of the matching results, the relevance calculator selection system selecting the given relevance calculator based on relevance configuration inputs.

Example 6 is the computer system of any or all previous examples and further comprising:

a search behavior configuration component that generates user input mechanisms that receive search behavior configuration inputs, the search characteristics including the search behavior configuration inputs, the search behavior configuration component configuring the search system based on the search behavior configuration inputs.

Example 7 is the computer system of any or all previous examples wherein the search behavior configuration component generates a sort behavior user input mechanism that receives a sort behavior input and configures the given sorting system to sort the results based on the sort behavior input. Example 8 is the computer system of any or all previous examples wherein the sort behavior user input mechanism generates a sponsored results sort behavior user input mechanism that is actuated to define the sorting behavior to preferentially sort sponsored search results.

Example 9 is the computer system of any or all previous examples wherein the search behavior user input mechanism generates a related search results user input mechanism that is actuated to configure the search system to include, in the search results, related search results generated from a prior search.

Example 10 is the computer system of any or all previous examples and further comprising:

a data analytics component that performs analysis on the search results and identifies additional search results based on the analysis, the search behavior user input mechanism generating an analytics user input mechanism that is actuated to configure the search system to include, in the search results, related search results that are identified as related to the search results by the analysis performed by the analytics component.

Example 11 is the computer system of any or all previous examples wherein the search behavior configuration component generates a data mining user input mechanism that receives a data mining behavior input indicative of data mining behavior of a data mining component, the data mining behavior comprising a time when a searchable view of the business data store is generated relative to receiving the search user inputs, the search behavior configuration component configuring the given data provider to mine data from the business data store based on the data mining behavior.

Example 12 is the computer system of any or all previous examples wherein the user search inputs comprise a query and wherein the search behavior configuration component generates a query configuration user input mechanism that receives a query configuration input and configures the search system to process the query based on the query configuration input.

Example 13 is the computer system of any or all previous examples wherein the search behavior configuration component generates a result display configuration user input mechanism that receives a result display configuration input and configures the result display component to display the search results based on the result display configuration input.

Example 14 is the computer system of any or all previous examples wherein the search behavior configuration component generates a query content configuration user input mechanism that receives a query content configuration input and configures the search system to include identified record content from records in the business data store in the search results.

Example 15 is the computer system of any or all previous examples wherein the search behavior configuration component generates a result scoping configuration user input mechanism that receives a result scoping configuration input and configures the search system to processes the search parameters according to a scoping strategy to modify recall corresponding to the search parameters.

Example 16 is the computer system of any or all previous examples wherein the search behavior configuration component generates a search result limiting configuration user input mechanism that receives a search result limiting configuration input and configures the search system to limit a number of search results returned and wherein the search behavior configuration component further comprises a performance handling user input mechanism that is actuated to configure the search system to apply a set of rules to modify search behavior based on a combination of the data mining input and the search result limiting input.

Example 17 is a method, comprising:

generating a set of transactional search configuration user input mechanisms that are actuated to receive configuration inputs defining transactional search behavior; and

configuring a transactional search system within a computer system to perform transactional searches in the computer system, based on search user inputs, according to the defined transactional search behavior, wherein the defined transactional search behavior includes selecting, based on a given search user input, a given search component, from a plurality of selectable search components, to perform a given transactional search.

Example 18 is the method of any or all previous examples wherein configuring the transactional search system comprises:

configuring the transactional search system to select a given data provider to execute the given transactional search and obtain matching search results, based on characteristics of the given transactional search, itself; and

configuring the transactional search system to select a sorting system to sort the matching search results.

Example 19 is a computer system, comprising:

a transactional search system that performs a transactional search for information in the computer system based on search user inputs, according to a search behavior, the search behavior including selecting a data provider to execute a given transactional search based on characteristics of the given transactional search; and

a transactional search configuration system that generates search behavior user input mechanisms corresponding to different behavioral characteristics of the transactional search system, the search behavior user input mechanisms receiving configuration inputs that define the search behavior of the transactional search system, the transactional search configuration system configuring the transactional search system to perform the search according to the search behavior.

Example 20 is the computer system of any or all previous examples and further comprising:

an application component that runs a business application and generates user interface displays defining a transaction context within which the transaction search system receives the search user inputs.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claim.

What is claimed is:

1. A computer system, comprising:
a search system, comprising:
a user interface system that generates a user interface display in a transactional context, with a search user input mechanism and generates search parameters based on search user inputs received through the search user input mechanism;
a search selection system that selects a given search component, from a plurality of different selectable search components, for performing a search using the search parameters to obtain search results, the search selection system selecting the given search based on search characteristics; and
a result display component that receives the search results and generates a search result display based on the search results; and
an application component that runs an application that defines at least a portion of the user interface displayed by the user interface system.

2. The computer system of claim 1 wherein the search selection system comprises:
a data provider selection system that selects a given data provider, from a plurality of different selectable data providers, for execution of the search using the search parameters to obtain search results, the data provider selection system selecting the given data provider based on the search characteristics.

3. The computer system of claim 2 wherein the computer system comprises a business system and wherein the given data provider searches a business data store for business records matching the search parameters.

4. The computer system of claim 3 and further comprising:
a sort selection system that selects a given sorting system, from a plurality of different selectable sorting systems, to sort matching results identified by the given data provider, the sort selection system selecting the given sorting system based on sort configuration inputs.

5. The computer system of claim 4 and further comprising:
a relevance calculator selection system that selects a given relevance calculator, from a plurality of different selectable relevance calculators, to calculate a relevance value for each of the matching results, the relevance calculator selection system selecting the given relevance calculator based on relevance configuration inputs.

6. The computer system of claim 2 and further comprising:
a search behavior configuration component that generates user input mechanisms that receive search behavior configuration inputs, the search characteristics including the search behavior configuration inputs, the search behavior configuration component configuring the search system based on the search behavior configuration inputs.

7. The computer system of claim 4 wherein the search behavior configuration component generates a sort behavior user input mechanism that receives a sort behavior input and configures the given sorting system to sort the results based on the sort behavior input.

8. The computer system of claim 7 wherein the sort behavior user input mechanism generates a sponsored results sort behavior user input mechanism that is actuated to define the sorting behavior to preferentially sort sponsored search results.

9. The computer system of claim 7 wherein the search behavior user input mechanism generates a related search results user input mechanism that is actuated to configure the search system to include, in the search results, related search results generated from a prior search.

10. The computer system of claim 7 and further comprising:
a data analytics component that performs analysis on the search results and identifies additional search results based on the analysis, the search behavior user input mechanism generating an analytics user input mechanism that is actuated to configure the search system to include, in the search results, related search results that are identified as related to the search results by the analysis performed by the analytics component.

11. The computer system of claim 6 wherein the search behavior configuration component generates a data mining user input mechanism that receives a data mining behavior input indicative of data mining behavior of a data mining component, the data mining behavior comprising a time when a searchable view of the business data store is generated relative to receiving the search user inputs, the search behavior configuration component configuring the given data provider to mine data from the business data store based on the data mining behavior.

12. The computer system of claim 6 wherein the user search inputs comprise a query and wherein the search behavior configuration component generates a query configuration user input mechanism that receives a query configuration input and configures the search system to process the query based on the query configuration input.

13. The computer system of claim 6 wherein the search behavior configuration component generates a result display configuration user input mechanism that receives a result display configuration input and configures the result display component to display the search results based on the result display configuration input.

14. The computer system of claim 6 wherein the search behavior configuration component generates a query content configuration user input mechanism that receives a query content configuration input and configures the search system to include identified record content from records in the business data store in the search results.

15. The computer system of claim 6 wherein the search behavior configuration component generates a result scoping configuration user input mechanism that receives a result scoping configuration input and configures the search system to processes the search parameters according to a scoping strategy to modify recall corresponding to the search parameters.

16. The computer system of claim 11 wherein the search behavior configuration component generates a search result limiting configuration user input mechanism that receives a search result limiting configuration input and configures the search system to limit a number of search results returned and wherein the search behavior configuration component further comprises a performance handling user input mechanism that is actuated to configure the search system to apply a set of rules to modify search behavior based on a combination of the data mining input and the search result limiting input.

17. A method, comprising:
generating a set of transactional search configuration user input mechanisms that are actuated to receive configuration inputs defining transactional search behavior; and
configuring a transactional search system within a computer system to perform transactional searches in the computer system, based on search user inputs, according to the defined transactional search behavior, wherein the defined transactional search behavior includes selecting, based on a given search user input, a given search component, from a plurality of selectable search components, to perform a given transactional search.

18. The method of claim 17 wherein configuring the transactional search system comprises:
configuring the transactional search system to select a given data provider to execute the given transactional search and obtain matching search results, based on characteristics of the given transactional search, itself; and
configuring the transactional search system to select a sorting system to sort the matching search results.

19. A computer system, comprising:
a transactional search system that performs a transactional search for information in the computer system based on search user inputs, according to a search behavior, the search behavior including selecting a data provider to execute a given transactional search based on characteristics of the given transactional search; and
a transactional search configuration system that generates search behavior user input mechanisms corresponding to different behavioral characteristics of the transactional search system, the search behavior user input mechanisms receiving configuration inputs that define the search behavior of the transactional search system, the transactional search configuration system configuring the transactional search system to perform the search according to the search behavior.

20. The computer system of claim 19 and further comprising:
an application component that runs a business application and generates user interface displays defining a transaction context within which the transaction search system receives the search user inputs.
